(19) United States
(12) Patent Application Publication
(10) Pub. No.: US 2023/0078872 A1
(43) Pub. Date: Mar. 16, 2023

(54) SYSTEMS AND METHODS FOR PERFORMANCE ADVERTISING SMART OPTIMIZATIONS

(71) Applicant: Sprinklr, Inc., New York, NY (US)

(72) Inventors: Vasant Srinivasan, Trichy (IN); Anand Kumar Singh, Pune (IN); Ayub Subhaniya, Sikka (IN); Ayush Jain, Ahmedabad (IN); Divyanshu Shekhar, Samastipur (IN); Yogin Patel, Gandhinagar (IN)

(21) Appl. No.: 17/942,000

(22) Filed: Sep. 9, 2022

Related U.S. Application Data
(60) Provisional application No. 63/242,755, filed on Sep. 10, 2021.

(51) Int. Cl. G06Q 30/02; G06N 20/00

(52) U.S. Cl. CPC G06Q 30/0277; G06N 20/00

(57) ABSTRACT

Systems and methods applicable to generating management decisions for online advertising. Machine learning models, including reinforcement learning-based machine learning models, can be utilized in making various advertising management decisions.

### CROSS-REFERENCE TO RELATED APPLICATIONS

This application claims priority to U.S. Provisional Patent Application Ser. No. 63/242,755, filed on Sep. 10, 2021, the contents of which are incorporated herein by reference in their entirety and for all purposes.

### FIELD OF THE INVENTION

The present technology relates to the field of generating management decisions for online advertising.

### BACKGROUND OF THE INVENTION

When implementing online advertising such as social network-based online advertising, various metrics can be measured. These metrics can include cost per mile (CPM), cost per action (CPA), and conversion rate (CR). Utilizing these and other metrics, various management decisions can be made.

For example, one management decision can be how to allocate budget among different ad campaigns, and/or among the ad sets of a given ad campaign. Another management decision can be deciding what bids should be made when securing online ads. Further still, management decisions can include targeting decisions.

According to conventional approaches, such management decisions are typically made by an advertising manager, perhaps informed by statistical analysis. As such, making these management decisions can be time consuming, and the quality of the decisions made can be highly dependent on the skill level of the advertising manager. Where automated assistance is available, such automated assistance can be lacking. For example, conventional automated assistance for allocating budget typically supports only shifting allocation among ad sets, not among ad campaigns. Further, such conventional automated assistance for allocating budget typically relies on delayed measurement, defines value in a way perhaps not applicable to an advertiser, and/or relies upon third party data and/or functionality.

In view of at least the foregoing, there is call for improved approaches for generating management decisions for online advertising, in an effort to overcome the aforementioned obstacles and deficiencies of conventional approaches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram depicting example ad campaigns, according to various embodiments.

FIG. 2 is a diagram depicting an example of the use of a machine learning model (MLM) in allocating a total budget among ad campaigns, according to various embodiments.

FIG. 3 is a further diagram depicting an example of the use of an MLM in allocating a total budget among ad campaigns, according to various embodiments.

FIG. 4 is a diagram depicting an example of policy evaluation and policy improvement, according to various embodiments.

FIG. 5 is an example plot depicting posterior gaussian distributions for a policy for two example ad sets, according to various embodiments.

FIG. 6 is an example plot depicting progression of bandit/ad entity selection, according to various embodiments.

FIG. 7 is an example plot depicting reward signal over time for multiple episodes for two example ad sets, according to various embodiments.

FIG. 8 is an example plot depicting policy gradient over time for two example ad sets, according to various embodiments.

FIG. 9 is a diagram depicting an example of the use of an MLM in deciding upon bids, according to various embodiments.

FIG. 10 is an example plot depicting bidding behavior time/cost, according to various embodiments.

FIG. 11 is a diagram depicting an example of the use of bid multipliers in addressing incrementality differences, according to various embodiments.

FIG. 12 is a diagram depicting an example of performances of different audience segments based on ad affinity, according to various embodiments.

FIG. 13 is a diagram depicting an example of the use of an MLM in generating bid multipliers, according to various embodiments.

FIG. 14 is a diagram depicting a target audience, according to various embodiments.

FIG. 15 is a diagram depicting an approach for retargeting ads, according to various embodiments.

FIG. 16 is an example plot depicting modeled CR, according to various embodiments.

FIG. 17 is an example look-back period plot, according to various embodiments.

FIG. 18 is an example plot depicting actual CPA versus estimated CPA, according to various embodiments.

FIG. 19 is an example daily seasonality plot, according to various embodiments.

FIG. 20 is an example plot of modeled seasonality, according to various embodiments.

FIG. 21 provides additional plots of modeled seasonality, according to various embodiments.

FIG. 22 is a diagram depicting an example maturity curve generation environment, according to various embodiments.

FIG. 23 is an example plot depicting an actual maturity curve, according to various embodiments.

FIG. 24 is an example plot depicting an estimated maturity curve, according to various embodiments.

FIG. 25 is an example plot depicting CPA trend variance reduction for an example period of time, according to various embodiments.

FIG. 26 shows an example computer, according to various embodiments.

### DETAILED DESCRIPTION

According to various embodiments, MLMs, including reinforcement learning (RL)-based MLMs, can be utilized in making various advertising management decisions. In this way, various benefits can accrue, including generating high-quality management decisions without having to rely upon a human advertising manager.

Various aspects, including using MLMs for allocating budget, deciding upon bids, and controlling targeting, will now be discussed in greater detail.

Allocating Budget via MLM

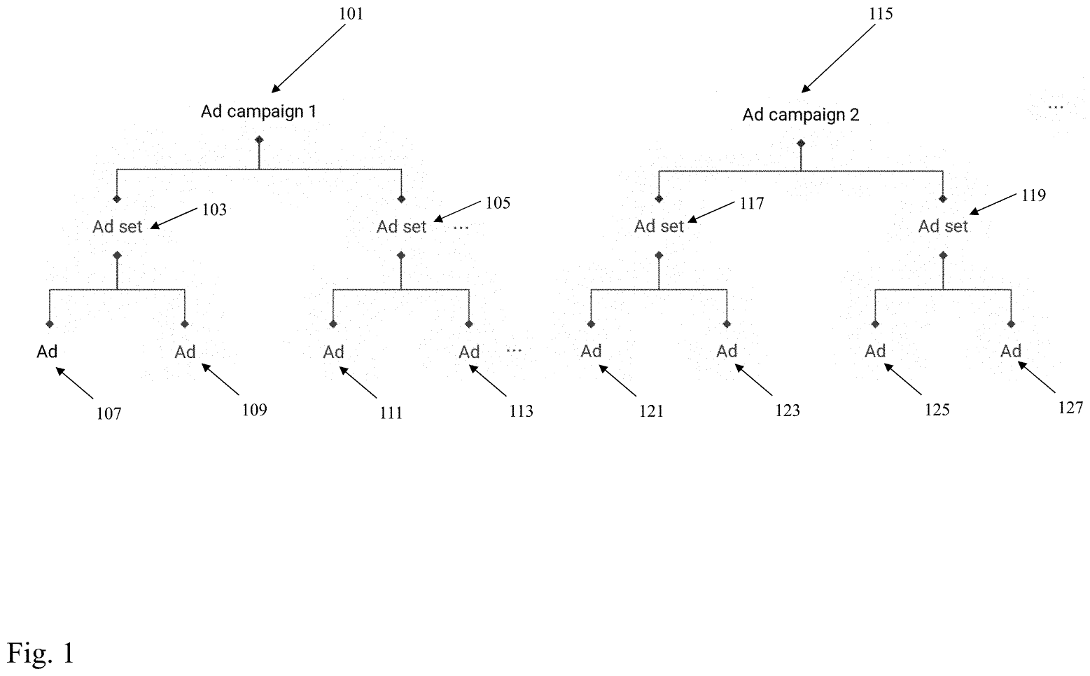

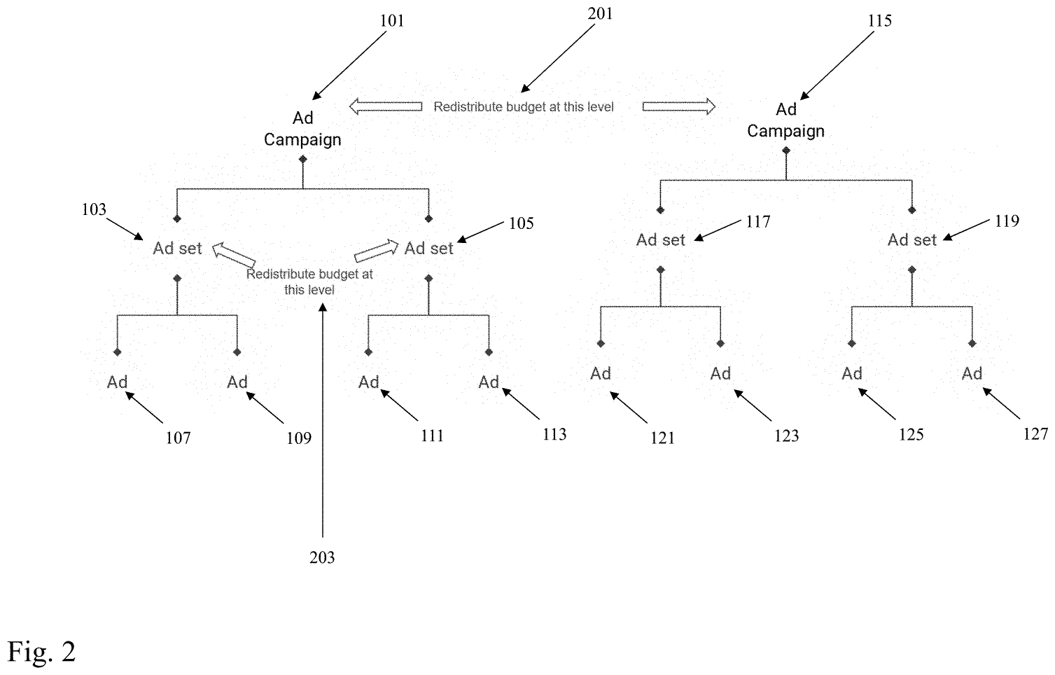

With reference to FIG. 1, in online advertising a given ad campaign can be made up of multiple ad sets. Each ad set can include a group of ads which share the same settings in terms of how, when, and where they are run. For instance, a certain ad campaign can include three ad sets, each ad set corresponding to a different city. Shown in FIG. 1 is ad campaign 1 (101) which is made up of ad set 103 and ad set 105. Ad set 103 includes ad 107 and ad 109, while ad set 105 includes ad 111 and ad 113. Additionally shown in FIG. 1 is ad campaign 2 (115) which is made up of ad set 117 and ad set 119. Ad set 117 includes ad 121 and ad 123, while ad set 119 includes ad 125 and ad 127. With reference to FIG. 2, an MLM can be utilized in allocating (201) a given total budget among various ad campaigns, and/or among various ad sets (203) of a given ad campaign.

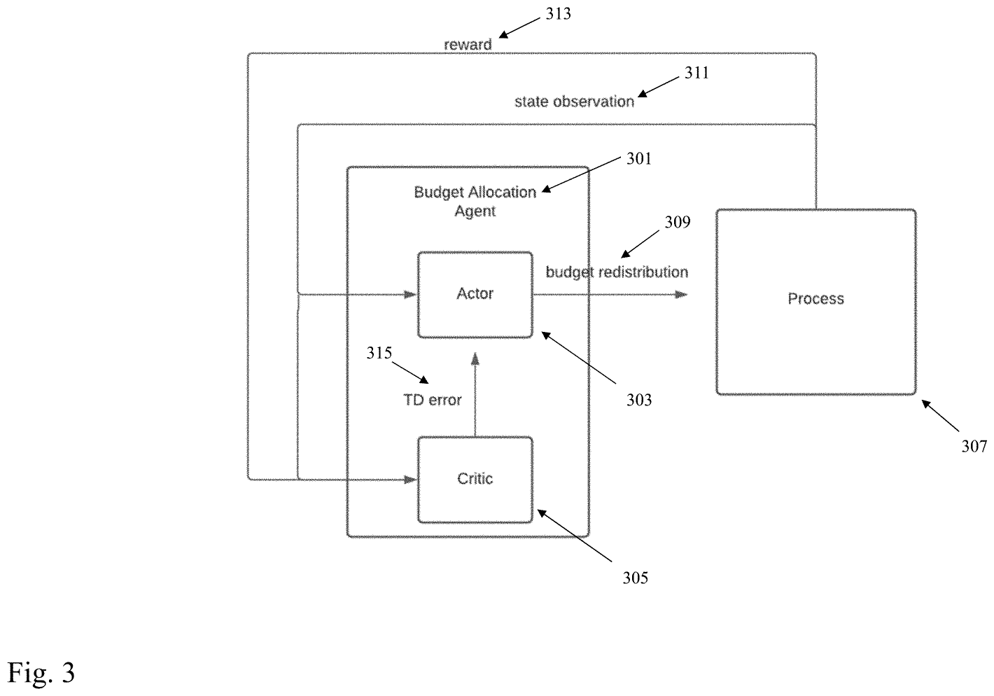

With reference to FIG. 3, it is noted that such an MLM can, in various embodiments, be RL-based. As opposed to viewing the allocation as a single-state problem, having the MLM be RL-based can allow it to learn a sequence of decisions which result in a satisfactory budget allocation result. Likewise, having the MLM be RL-based can allow the MLM to account for the fact that the results of its actions can often be delayed (e.g., by a few days). Through training, the RL-based MLM can learn to, for instance, move budget from higher-cost ad entities (i.e., ad campaigns and/or ad sets) to lower-cost (in terms of CR) ad entities. Once the MLM has attained an optimal state, the CPA of each ad entity can be similar.

As depicted by FIG. 3, the RL-based MLM can be a budget allocation agent 301 which includes an actor 303 and a critic 305. The actor-critic MLM of FIG. 3 can be implemented via a multi-arm bandit-based actor-critic algorithm. As other examples, the actor-critic MLM of FIG. 3 can be implemented via A2C or A3C. The process/environment 307 can be an online advertisement environment (e.g., a social network). The process/environment can receive actions (labeled “budget redistribution” 309) from the actor. Further, the process/environment can transition between states, and can issue rewards. The state of the process/environment can be observed (311) by the actor and critic. Further, rewards issued by the process/environment can be observed (313) by the critic. Also, the critic can generate an error signal 315, such as a temporal difference (TD) error signal, to the actor. This error signal can be used to update parameters of the actor, such as neural network weights. Further, the critic can learn to more accurately generate the error signal, for instance more accurately learning to determine the value of a given state of the environment.

The actions performed by the actor can include specifying, for each of the ad entities under consideration, a budget allocation for that ad entity. As an example, the actor can output a multi-armed bandit style vector, where each element of the vector indicates a budget allotment for a given ad entity/“bandit.” As a specific illustration, for a circumstance of three ad entities the actor might output the vector [0.1, 0.2, 0.7], representing the budget split. The reward issued by the environment can regard a CPA penalty and/or a spend penalty, as discussed hereinbelow. The observable state variables can include, for example, spend rate (SR), CPA, pacing, CPM, and conversion rate.

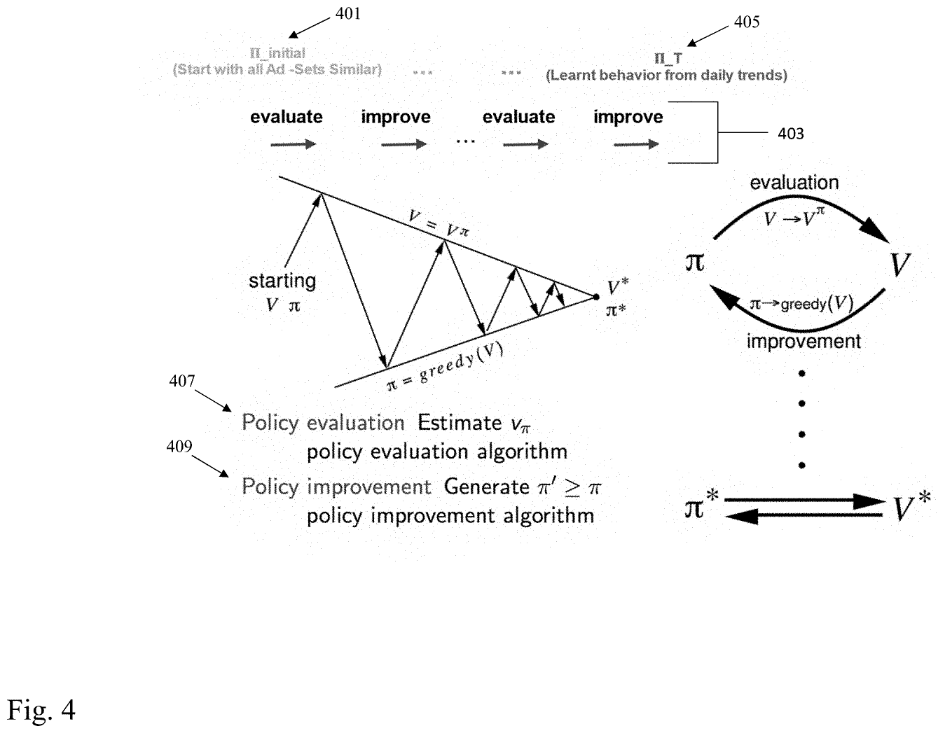

With reference to FIG. 4, the MLM can start with an initial policy, π_initial 401. According to this initial policy, the actor can equally distribute budget among the various at-hand ad entities (e.g., ad sets). Then, through a process of repeated policy evaluation and policy improvement 403, the policy can be improved. In particular, through this improvement the policy can finally converge to a final policy π_T 405. As such, the final policy π_T can reflect a policy behavior which the MLM has learned via interaction with the process/environment. As reflected by FIG. 4, policy evaluation algorithms 407 and policy improvement algorithms 409 can be used. As also reflected by FIG. 4, in various embodiments the MLM can utilize a greedy method when balancing exploration vs. exploitation during training.

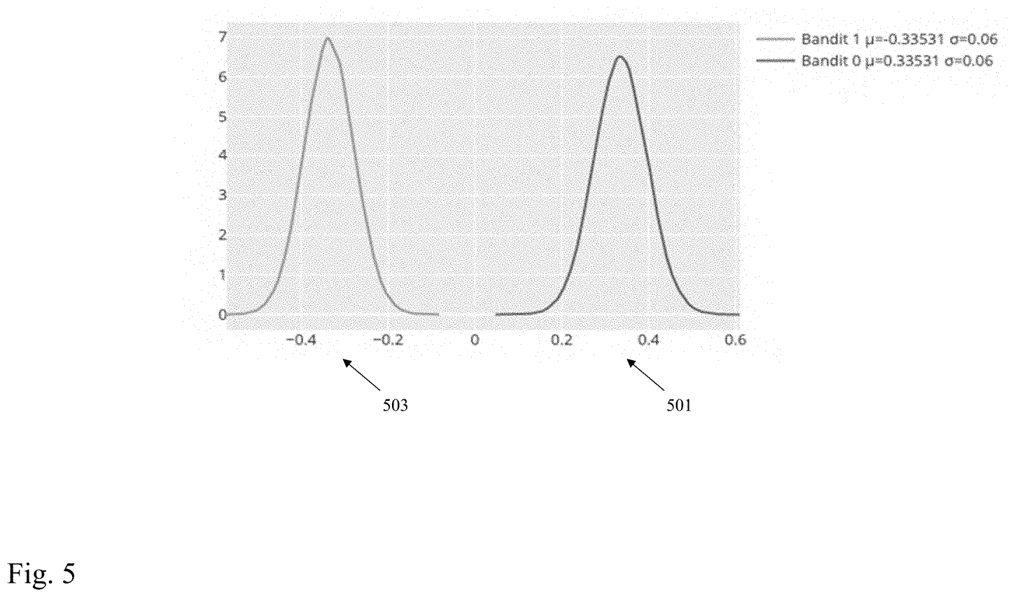

Further considering policy evaluation, in various embodiments a Bayesian policy/multi-armed bandit approach can be taken. Here, a prior gaussian distribution for the policy can first be specified. Then, based on observations (i.e., interactions with the process environment), the distribution can be revised so as to yield an updated/posterior Gaussian distribution for the policy. Subsequently, a predictive gaussian distribution for the policy can be calculated from the updated/posterior distribution. Within these distributions for the policy, the mean (μ) can correspond to the entity value (e.g., ad set value) and the variance (σ) can denote the inverse of the information entropy. Shown in FIG. 5 are two example posterior gaussian distributions for the policy for two example ad sets, listed as “bandit 0” (501) and “bandit 1” (503).

Still further considering policy evaluation, according to various embodiments a softmax/Boltzmann exploration approach can be taken to address the exploration/exploitation dilemma. In particular, the problem can be framed as a multi-armed bandit problem, where each of the at-hand ad entities is a bandit. Here, selection of a bandit/ad entity can correspond to allocating budget to it. As such, when exploring, the probability of selecting/allocating budget to a given bandit/ad entity Pᵢ (i.e., the “win probability” for that bandit/ad entity) can be calculated as a softmax on gaussian:

$${P}_{i} = \frac{exp ( {q}_{i} / τ )}{{\sum }_{j = 1}^{n} exp ( {q}_{j} / τ )}$$

Where τ is the divergence constant/temperature factor, which specifies how many bandits/ad entities can be explored (when τ is high, all bandits/ad entities are explored equally; when τ is low high-reward bandits/ad entities are favored). In this equation, qᵢ is calculated as:

qᵢ=μᵢ+k*σᵢ

Where k is the exploration constant. qᵢ is calculated analogously. Here, a gaussian distribution can be used to model a quality-of-ad-entity abstract variable. The use of a gaussian distribution can make the policy stochastic. Softmax can be used to get budget proportions from the underlying gaussian. The composition of the gaussian distribution and softmax can yield the policy. In other embodiments, a distribution other than a gaussian distribution can be used.

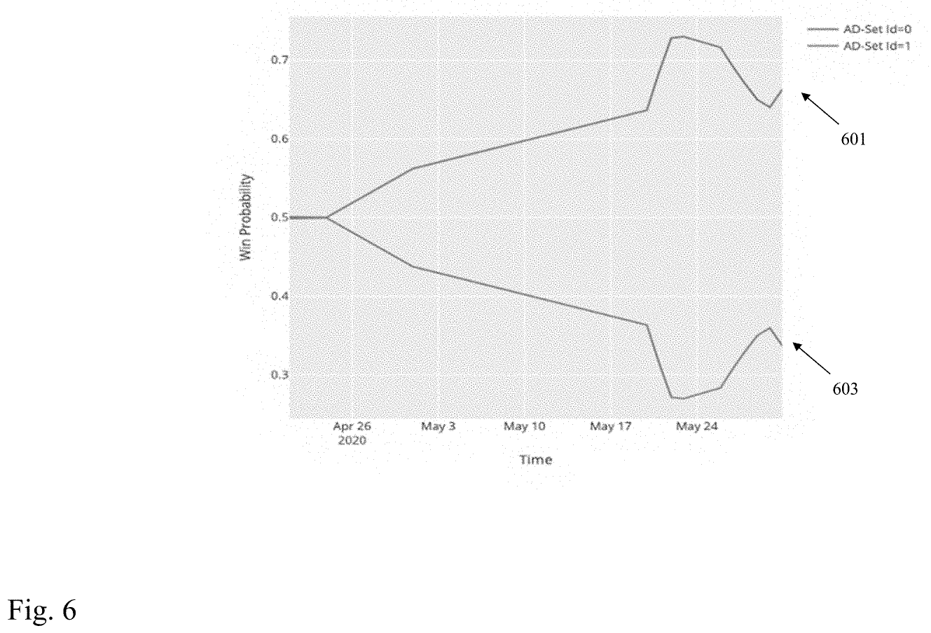

Shown in FIG. 6 is the progression of bandit/ad entity selection as time progresses, according to an example. Depicted in FIG. 6 are ad set 0 (601) and ad set 1 (603). Here, as time progresses ad set 0 is selected/receives allocation more frequently, as it proves to be the higher-reward bandit/ad entity.

Turning to policy improvement, as referenced the reward can regard a CPA penalty and/or a spend penalty. More specifically, the reward signal R can be calculated as penalty_{cpa}+penaltyₛₚₑₙₜ, where:

$${penalty}_{cpa} = \frac{{cpa}_{ach} - {cpa}_{esi}}{{cpa}_{ach}} \\ {penalty}_{spend} = \frac{2 * ( 1 - SR )}{SR}$$

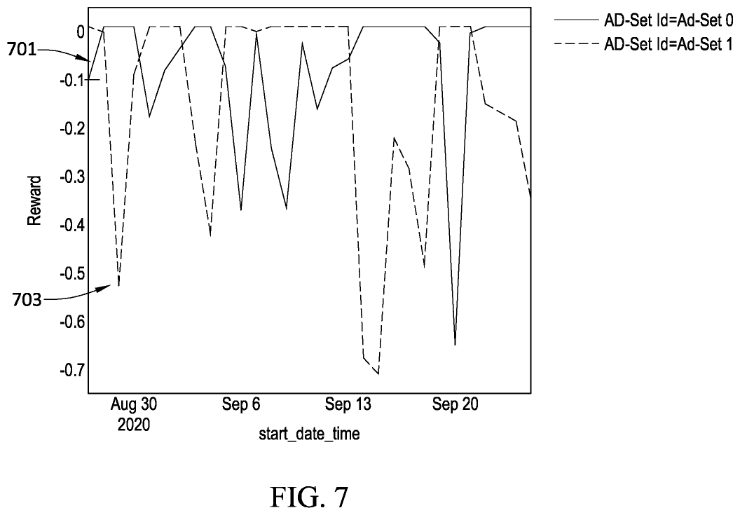

Here, cpa_{ach} indicates achievable CPA, cpaₑₛₜ indicates estimated CPA, and SR indicates spend rate. In various embodiments, penalty can be normalized using tan h( ) Shown in FIG. 7 is the reward signal over time for multiple episodes for two example ad sets, ad set 0 (701) and ad set 1 (703).

With further regard to policy improvement, the policy gradient ∇_{μ} can be calculated according to:

$$▽μ = ( {▽}_{u} {π}_{μ} ) R \\ {▽}_{μ} {π}_{μ} = \{ \begin{matrix}\frac{1}{τ} * {P}_{i} * ( 1 - {P}_{j} ) & i == j \\ - \frac{1}{τ} * {P}_{i} * {P}_{j} & otherwise\end{matrix}$$

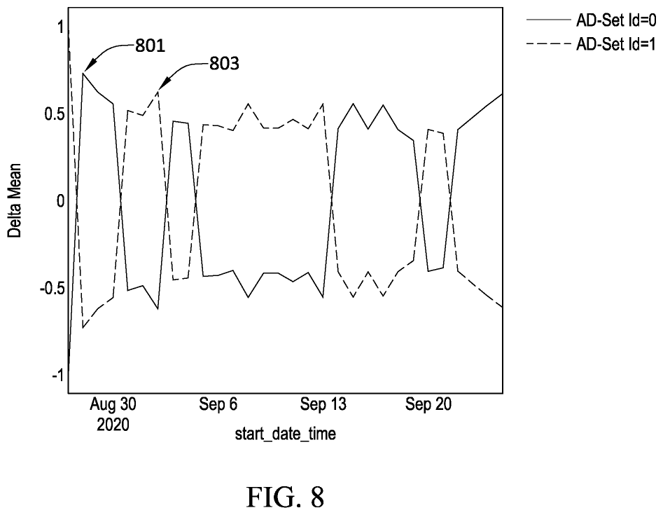

Shown in FIG. 8 is the policy gradient, expressed as delta mean (i.e., the update/perturbation of gaussian distribution's mean), over time for multiple episodes, for two example ad sets, ad set 0 (801) and ad set 1 (803).

Bid Optimization via MLM

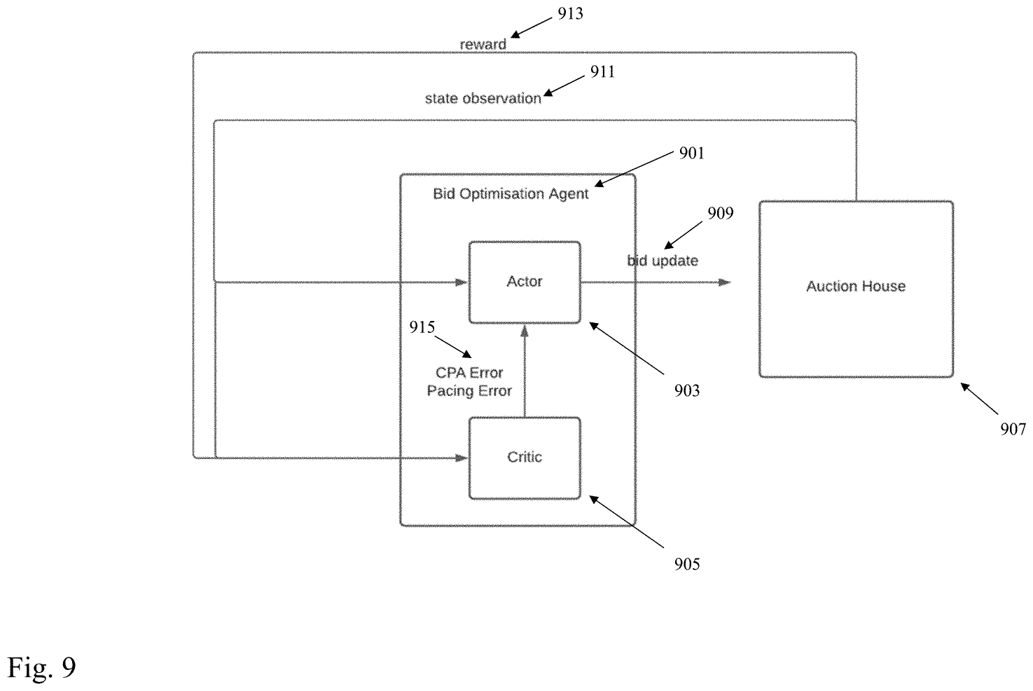

Considering bidding policy iteration, with reference to FIG. 9, an RL-based MLM can, in various embodiments, be utilized in deciding upon bids. The RL-based MLM can, through training, learn to, for instance, make bids which attain maximum conversions, such as within a target cost. The MLM can include and actor and a citric. The training experience of the MLM can include the actor taking actions, and receiving CPA error and pacing error signals from the critic.

More generally, as depicted by FIG. 9 the RL-based MLM can be a bid optimization agent 901 which includes and actor 903 and a critic 905. The actor-critic MLM of FIG. 9 can be implemented via A3C. As another example, the actor-critic MLM of FIG. 9 can be implemented via A2C. The process/environment 907 can be an auction house for online advertisements (e.g., the ad auction house of a social network). The process/environment can receive actions (labeled “bid update” 909) from the actor. Further, the process/environment can transition between states, and can issue rewards. The state of the process/environment can be observed (911) by the actor and critic. Further, rewards issued by the process/environment can be observed (913) by the critic. The critic can generate the noted error signal 915 for the actor. This error signal can be used to update parameters of the actor, such as neural network weights. Further, the critic can learn to more accurately generate the error signal, for instance more accurately learning to determine the value of a given state of the environment.

The actions performed by the actor can, as noted, be bid updates. The reward issued by the environment can be based on estimated CPA, as discussed hereinbelow. The observable state variables can include, for example, conversion rate, spend rate, CPA, and CPM.

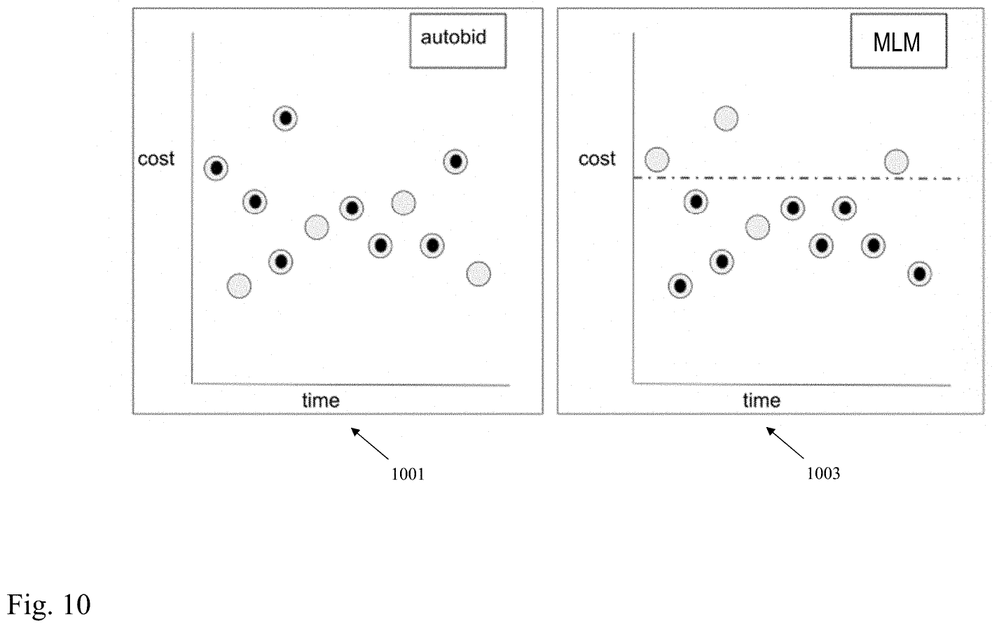

Considering pacing error, turning to FIG. 10, depicted are two time/cost graphs of bidding behavior. In particular, shown on the left side of FIG. 10 is the default autobid behavior 1001 for an auction house for online advertisements. Shown on the right side of FIG. 10 is bidding behavior utilizing an MLM of the sort noted 1003. Considering the left side of the figure, the auction house (or a social network to which it corresponds) has control of bidding, and has a mandate of spending all of a given budget. Considering the right side of the figure, according to the functionality discussed herein, a sequence of bids is made by the MLM, and attempt is made to achieve cost-limiting behavior. As such, the functionality discussed herein can yield benefits including reducing bid amounts such that less than all of a given budget is spent.

The MLM can operate in conjunction with the auction house such that it sets a maximum cost bid with the auction house, and then assumes control of bid optimization. Cost limiting the spend serves as a mechanism to lower the cost. Training of the MLM can include the actor learning to use the CPA error and pacing error signals received from the critic to achieve the cost limiting behavior depicted in FIG. 10 in which all of the money is spent while attaining a lower cost compared to autobid.

Considering CPA error, the policy employed by the MLM can yield a bid to be made with the auction house, given an observed state. In various embodiments, SR can be used as an additional or alternative error signal. Further, the reward function can be implemented in the following way. When the estimated CPA is more than the target CPA, reward can be defined using piecewise linear deviation of estimated CPA from target CPA. And, where the estimated CPA is below the target CPA, the reward can be defined using piecewise linear deviation of estimated pacing from desired pacing. The MLM can update its policy to move bid actions in a way that will achieve greater rewards. In some embodiments, the temporal difference algorithm can be used in such policy updates. The target CPA can, as just an example, be defined by a campaign manager based on business expectations/constraints.

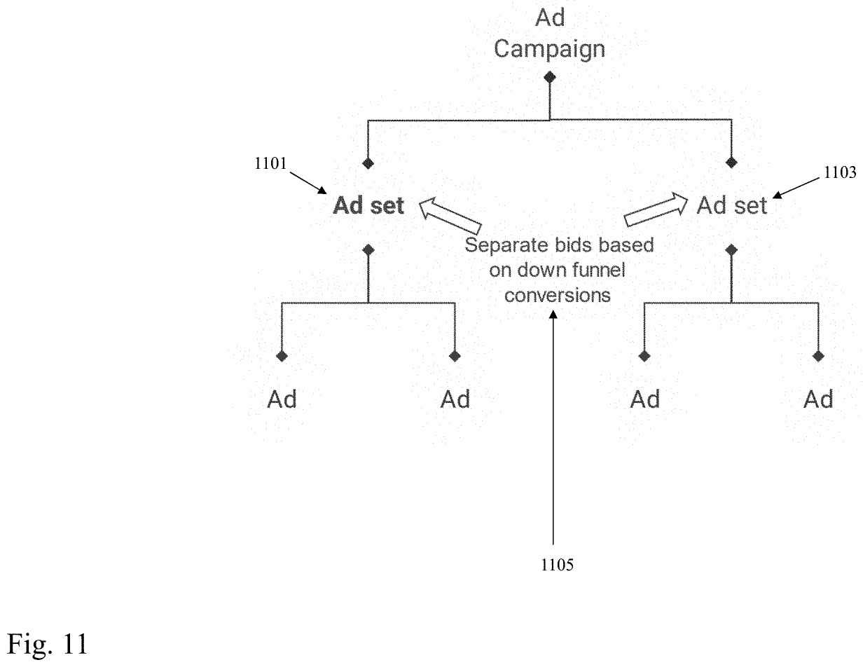

With reference to FIG. 11, in various embodiments bid multipliers can be used to address differences in incrementality across ad entities (e.g., ad set 1101 and ad set 1103). The bid multipliers can be implemented as an additional layer above the discussed bid optimization MLM functionality. In particular, the bid multipliers can be applied so as to bid differently (1105) for ad entities which exhibit different incrementality, thereby allowing bidding to appropriately account for incrementality. In various embodiments, the bid multiplier applied for a given ad entity can be the ratio of its CR to the highest CR among its ad entity siblings.

Target Optimization via MLM

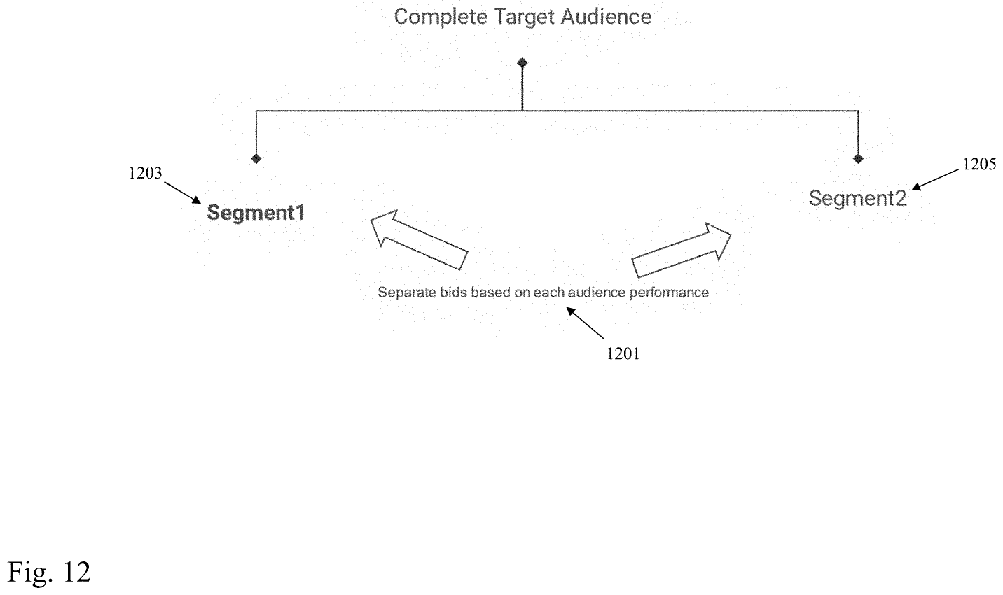

With reference to FIG. 12, the performances of different audience segments can be different based on their affinity to a given ad. In keeping with this, different bids can be used (1201) when bidding for an ad as directed to a first audience segment 1203 versus the ad as directed to a second audience segment 1205. Such different bids can be implemented via bid multipliers.

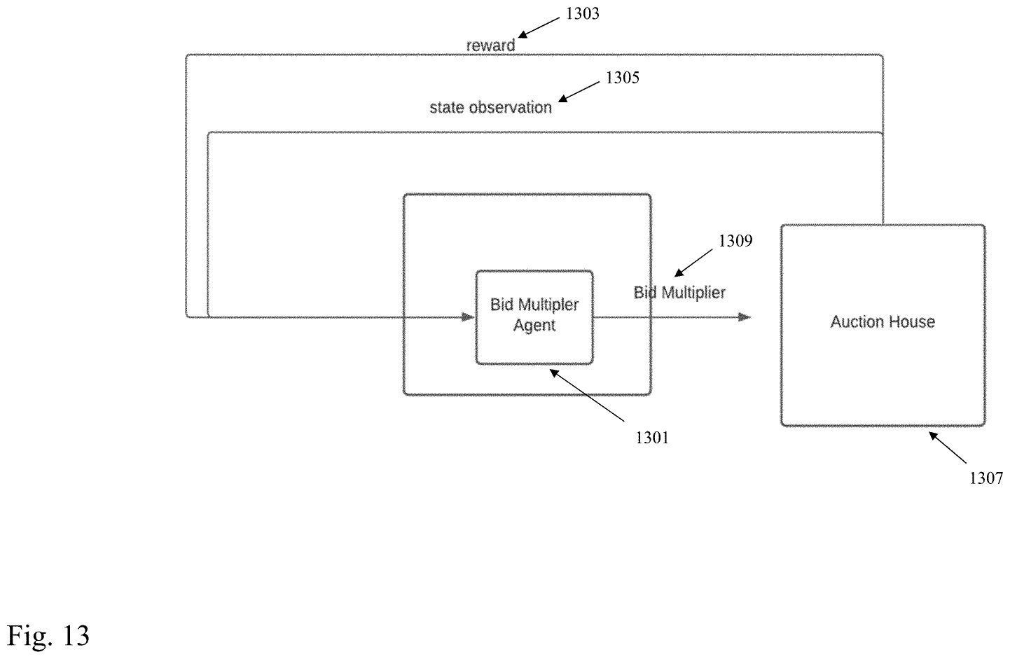

With reference to FIG. 13, an RL-based MLM can be trained and used to generate such bid multipliers. As depicted by FIG. 13, the MLM can include a bid multiplier agent 1301 which receives rewards 1303 and state observations 1305 from an auction house process/environment 1307, and which generates actions 1309. The rewards can be conversions. The states can be SR and CR for each of the segments. The actions can be bid multipliers which can be applied to bids generated by the bid optimization MLM discussed above. Based on the feedback from the process/environment (i.e., the rewards and state observations), the MLM can continuously adapt bidding in view of audience segment shifts in terms of ad affinity. Once the MLM has attained an optimal state, the CPA of each market segment can be similar. As just some examples, the RL-based MLM of FIG. 13 can be implemented via A3C or via A2C.

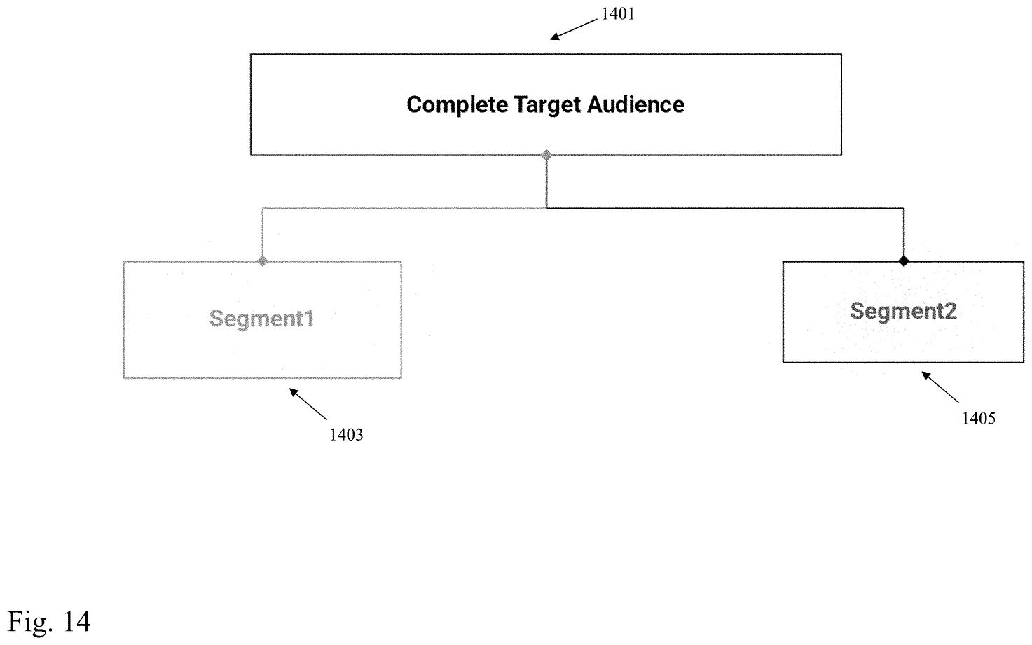

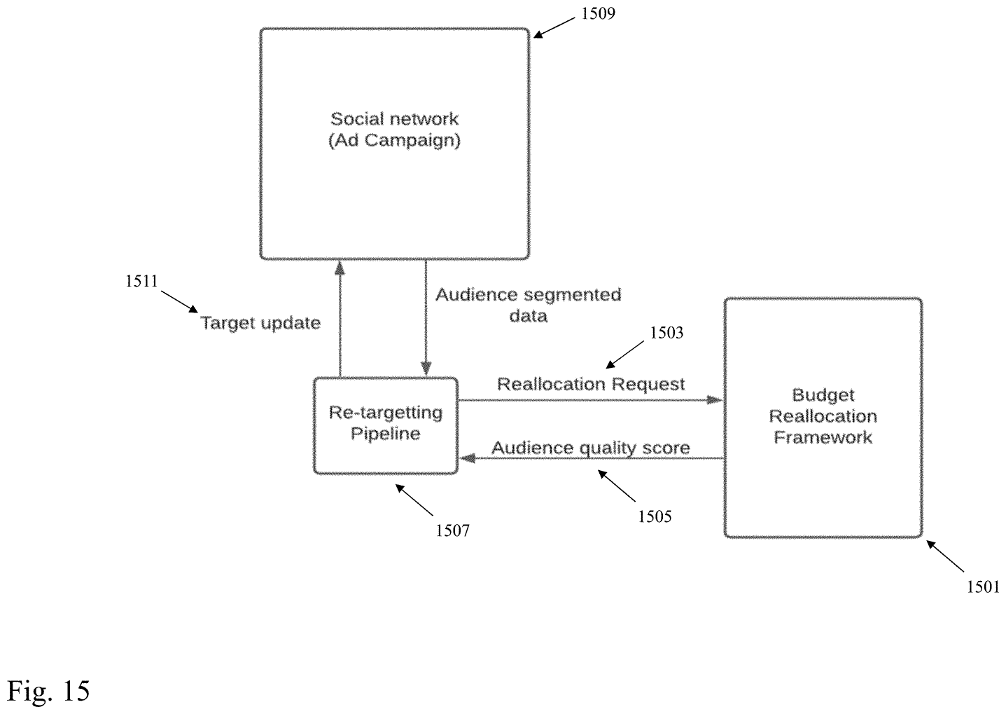

With reference to FIGS. 14 and 15, retargeting of ads will now be discussed. In various embodiments, the above-discussed budget allocation MLM can be utilized to identify the relative quality of audience segments. For example, as shown in FIG. 14 complete target audience 1401 can include audience segment 1 (1403) and audience segment 2 (1405). Here, the budget allocation MLM can identify the relative quality of audience segment 1 and the relative quality of audience segment 2. In particular, the budget level allocated by the MLM for a given ad entity (e.g., ad set) can be interpreted as the MLM's indication of the relative quality of that ad entity.

With reference to FIG. 15, the depicted budget reallocation framework 1501 can include the budget allocation MLM. In response to a reallocation request 1503 which specifies an ad entity, the framework can query the budget allocation MLM for the budget level allocated to that ad entity. The framework can use this budget allocation value to generate an audience quality score 1505 for the ad entity, and return it to the requestor. The requestor can be a retargeting pipeline 1507. Using the audience quality score, the retargeting pipeline can interact with an ad environment 1509 (e.g., a social network) to make targeting changes 1511. For example, where a market segment corresponding to a given ad entity (e.g., ad set) has a low audience quality score (e.g., according to audience segmented data 1513), the retargeting pipeline can request that the ad environment completely remove (or reduce) ads for that market segment. In this way, cost savings can be achieved.

Estimation Operations

In various embodiments, one or more estimation operations can be performed. These estimation operations can include cost (in terms of CR) estimations, pacing estimations (in terms of spend seasonality), and measurement delay operations.

Turning to CR estimation, the conversion from impression to action can be considered a Poisson process prior, where the Poisson lambda value (λ) is equal to the CR. Then, sampling CRs from the conjugate prior, a gamma distribution can be yielded. This gamma distribution can be used to estimate CR. As the process continues, more impressions can be received. In this way, β (impressions) can increase and the confidence on the sampled CR can increase.

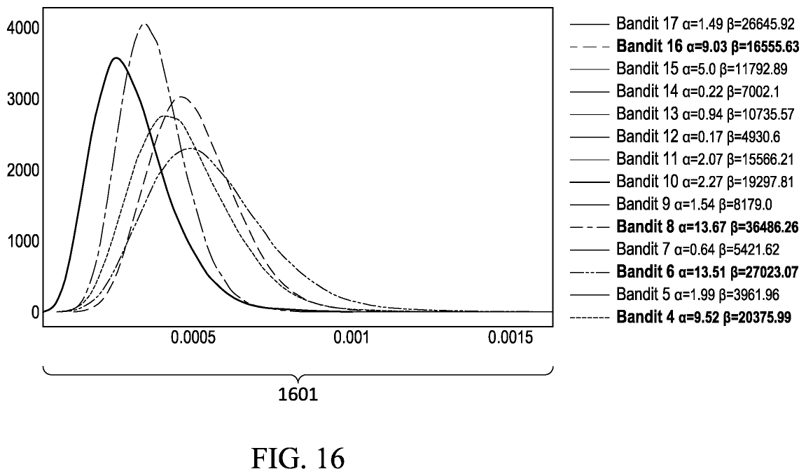

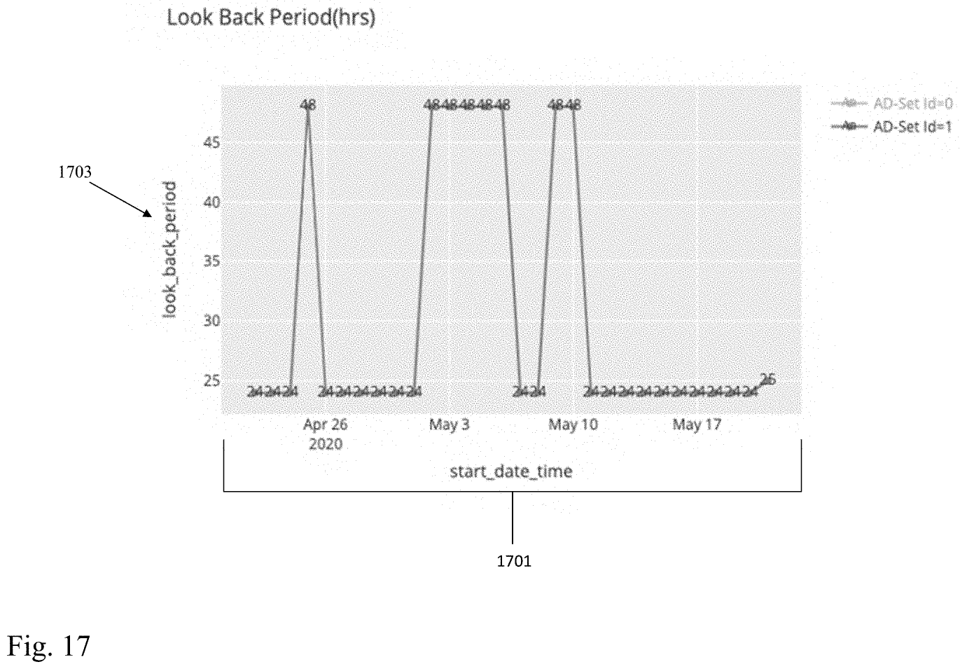

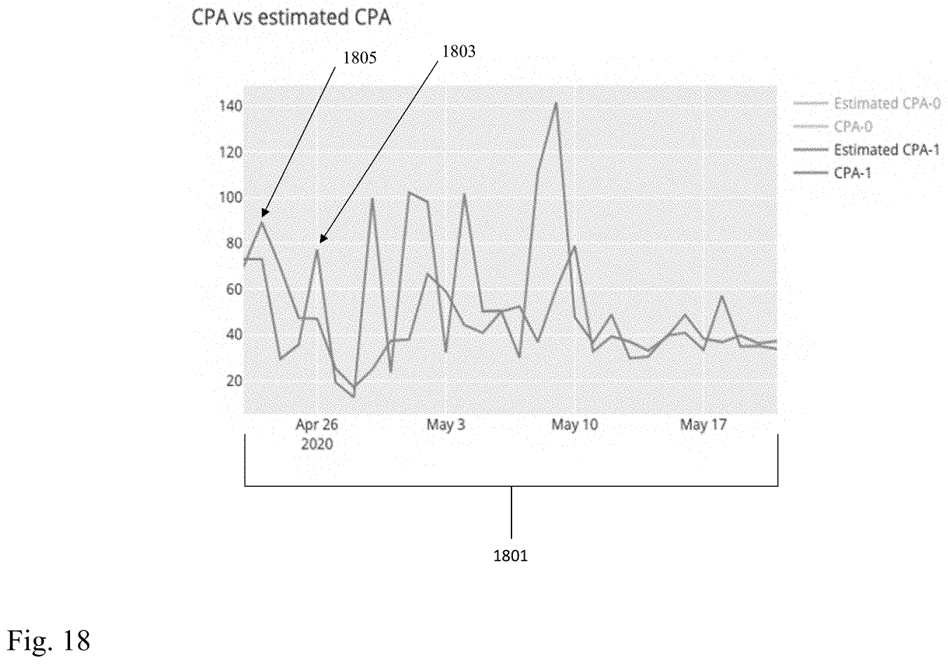

Shown in FIG. 16 is a plot 1601 of the CR modeled using the gamma distribution. Within the gamma distribution, α can correspond to actions and β can, as noted, correspond to impressions. α and β can be the sum of short-term and long-term history of metric with more weight to short-term. By using such a combination of short-term and long-term aggregates, the system can react to changing environmental behavior in an effective fashion. The look-back period can denote how much past data to use in short-term history calculation. Shown in FIG. 17 is a look-back period plot 1701, wherein the Y-axis 1703 is time in hours. Having estimated CR according to the foregoing, CPA can be calculated according to CPA=CPM/CR. Shown in FIG. 18 is a plot 1801 of actual CPA 1803 versus estimated CPA 1805 for an example ad set.

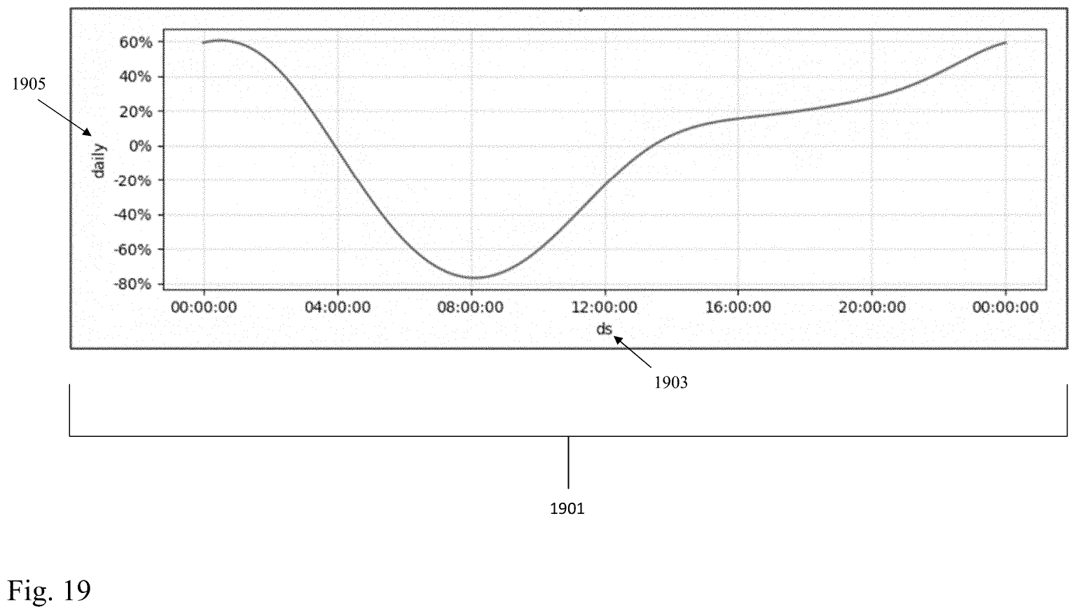

Turning to pacing (spend seasonality) estimation, it is noted that optimization opportunities can be missed when they lie within a given time block (e.g., within a day) and there is a lack intra-time block (e.g., intra-day) spend patterns. However, estimating budget pacing during a given time block (e.g., day) can be difficult, as spend of budget tends not to be linear throughout a given time block (e.g., day). As such, estimation of other time blocks can be needed. For example, where it is desired to estimate budget pacing during a day, there can be call to estimate daily and weekly spend seasonalities. Shown in FIG. 19 is an example of a typical daily seasonality plot 1901. Within this plot, the X-axis 1903 denotes the hour while the Y-axis 1905 denotes multiplicative seasonality.

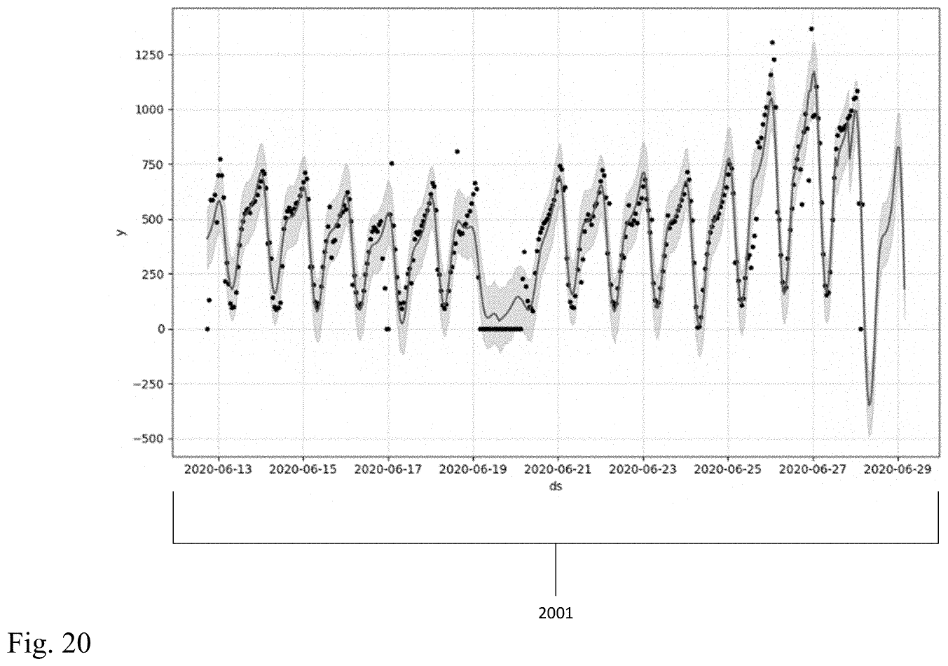

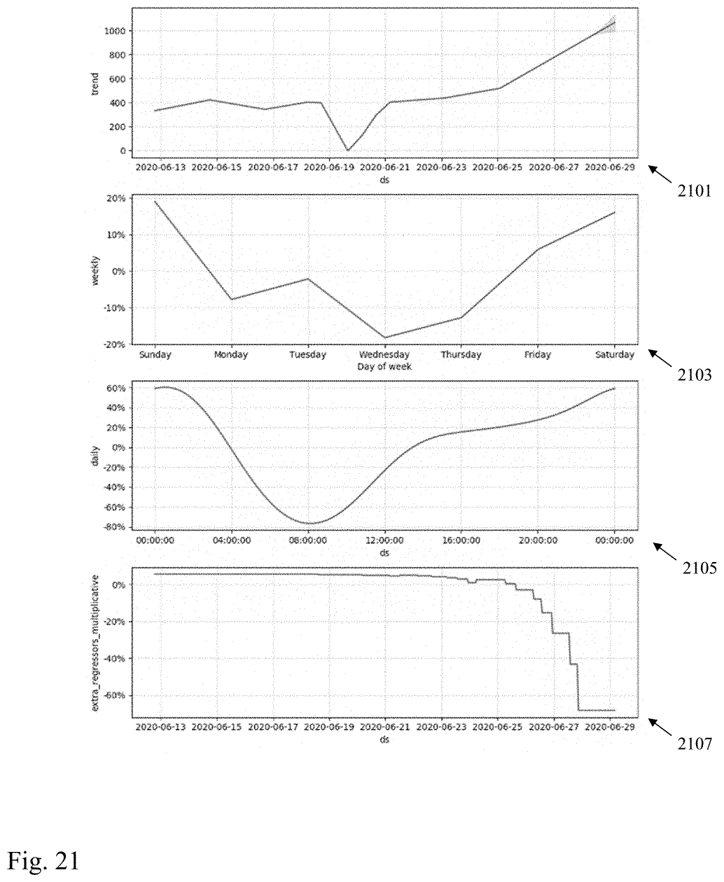

Shown in FIGS. 20 and 21 are various plots 2001, 2101, 2103, 2105, and 2107 of modeled seasonality, generating using Facebook Prophet. Prediction of spend incorporating seasonality and trend can be predicted in a number of ways. As examples, autoregressive integrated moving average (ARIMA), Holt-Winters, and Facebook Prophet can be used.

Turning to estimation of measurement delays, it is noted that measurements—such as those regarding ad performance—are often delayed. In line with this, decisions based on the conversions from most-recently collected impressions can be misleading as some impressions can be converted later on (e.g., a customer can visit a website linked by an ad, but not purchase the corresponding item until a later date). Maturity curves can be employed to tackle this issue. In various embodiments, gaussian process regression can be applied to multiple time series of a particular measurement. In this way, a corresponding measurement delay can be estimated. Such a maturity curve can be generated for each of those metrics under consideration (e.g., for CPA, CPM, and/or CR). Further, the maturity curves can be retrained daily so as to be kept up to date. Calculation of the estimated maturity curve can include consideration of the equation actions_{final}=actionsₜ*1/maturityₜ.

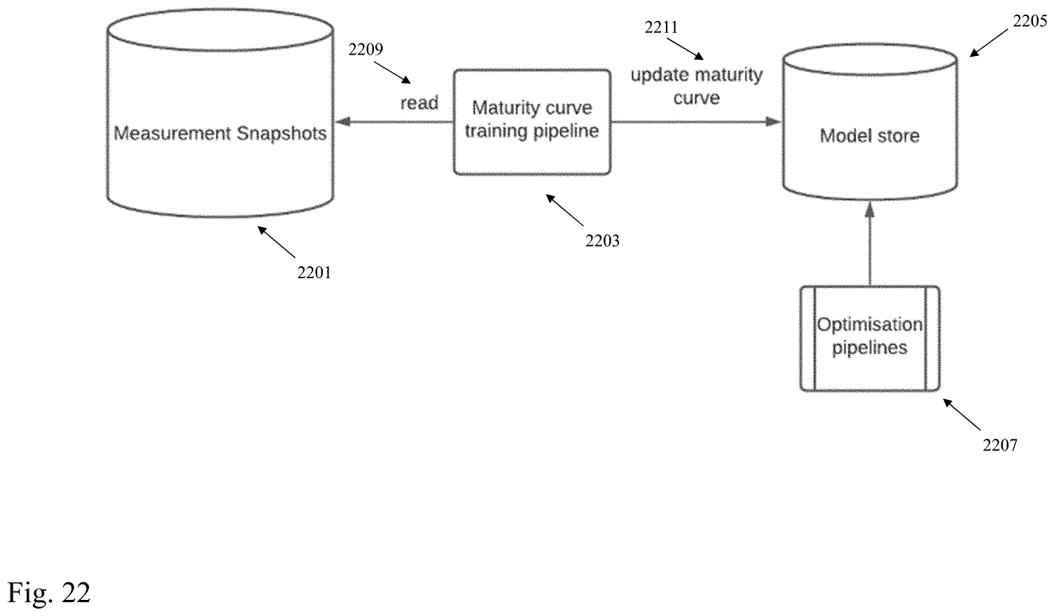

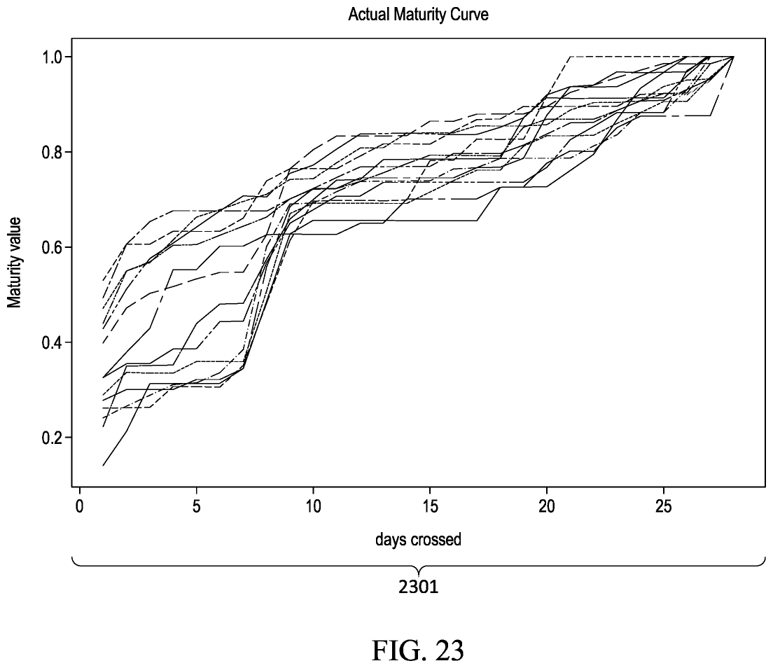

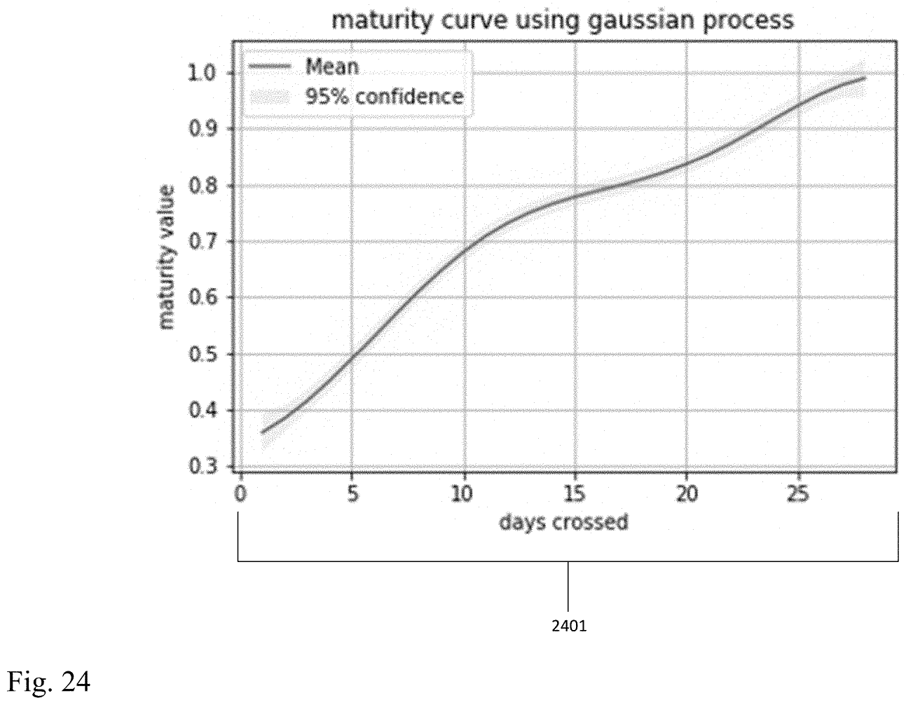

Shown in FIG. 22 is an exemplary environment for generating such maturity curves, including a measurement snapshots store 2201, a maturity curve training pipeline 2203, a model store 2205, and optimization pipelines 2207. As depicted by FIG. 22, the maturity curve training pipeline can read (2209) from the measurement snapshots store and can perform a maturity curve update (2211). Further, shown in FIGS. 23 and 24 are an example of an actual maturity curve 2301 along with a corresponding estimated maturity curve 2401, generated according to the foregoing.

Example Results

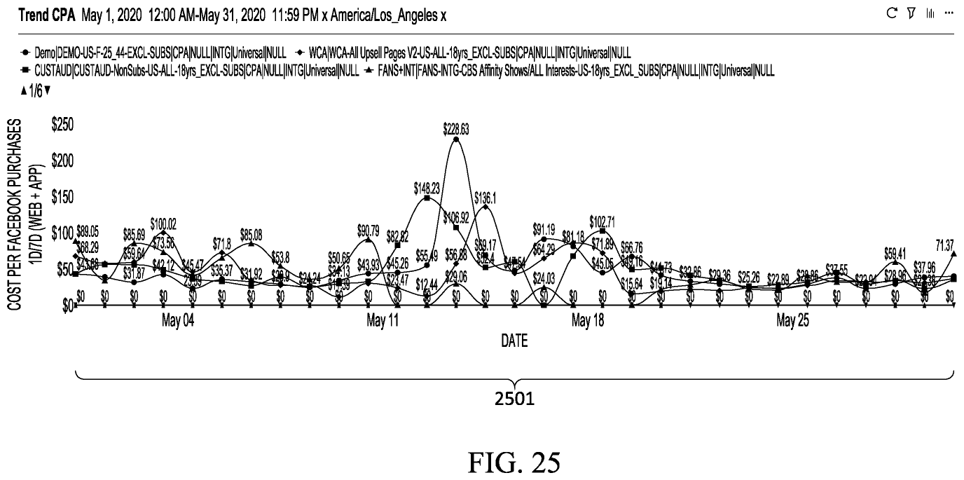

Via application of the approaches discussed herein, benefits such as reduction of CPA. Depicted in FIG. 25 is a plot 2501 showing CPA trend variance reduction for an example period of time.

Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

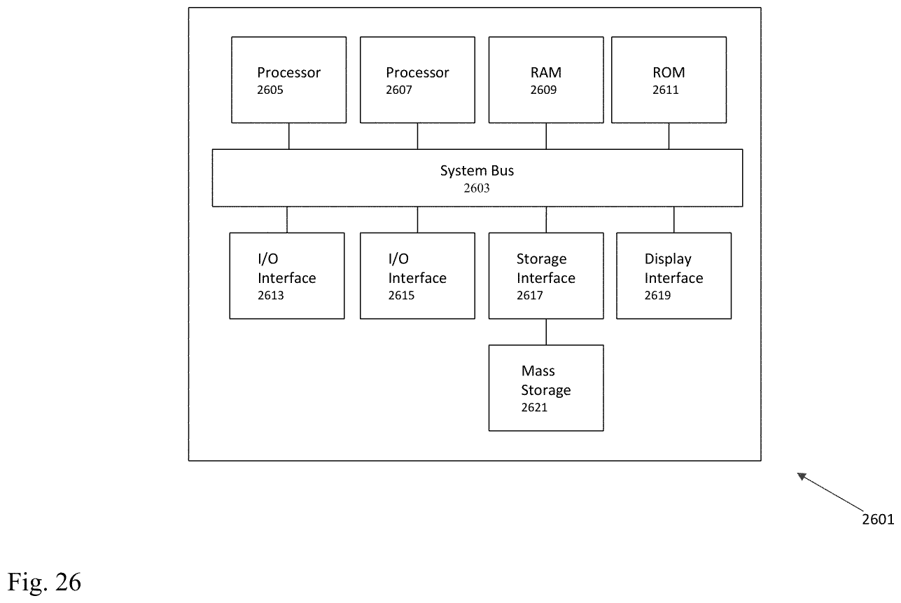

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 26 is an example computer employable in various embodiments of the present invention. Example computer 2601 includes system bus 2603 which operatively connects two processors 2605 and 2607, random access memory (RAM) 2609, read-only memory (ROM) 2611, input output (I/O) interfaces 2613 and 2615, storage interface 2617, and display interface 2619. Storage interface 2617 in turn connects to mass storage 2621. Each of I/O interfaces 2613 and 2615 can, as just some examples, be a Universal Serial Bus (USB), a Thunderbolt, an Ethernet, a Bluetooth, a Long Term Evolution (LTE), a 5G, an IEEE 488, and/or other interface. Mass storage 2621 can be a flash drive, a hard drive, an optical drive, or a memory chip, as just some possibilities. Processors 2605 and 2607 can each be, as just some examples, a commonly known processor such as an ARM-based or x86-based processor. Computer 2601 can, in various embodiments, include or be connected to a touch screen, a mouse, and/or a keyboard. Computer 2601 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

Ramifications and Scope

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
providing, by a computing system, to a reinforcement learning-based machine learning model, observations received from an online advertisement environment; and
receiving, by the computing system, from the reinforcement learning-based machine learning model, one or more budget allocation actions,
wherein training of the reinforcement learning-based machine learning model seeks a policy that minimizes penalty reward issued by the online advertisement environment.

2. The computer-implemented method of claim 1, wherein the observations received from the online advertisement environment comprise one or more of spend rate, cost per action, pacing, cost per mile, or conversion rate.

3. The computer-implemented method of claim 1, wherein the reinforcement learning-based machine learning model includes an actor and a critic.

4. The computer-implemented method of claim 1, wherein the reinforcement learning-based machine learning model is implemented via a multi-arm bandit-based actor-critic algorithm, A2C, or A3C.

5. The computer-implemented method of claim 1, wherein the budget allocation actions specify, for each of multiple ad entities, a budget allocation.

6. The computer-implemented method of claim 1, wherein the penalty reward comprises one or more of a cost per action penalty or a spend penalty.

7. A system comprising:
at least one processor; and
a memory storing instructions that, when executed by the at least one processor, cause the system to perform the computer-implemented method of claim 1.

8. A non-transitory computer-readable storage medium including instructions that, when executed by at least one processor of a computing system, cause the computing system to perform the computer-implemented method of claim 1.

9. A computer-implemented method, comprising:
providing, by a computing system, to a reinforcement learning-based machine learning model, observations received from an online advertisement auction house environment; and
receiving, by the computing system, from the reinforcement learning-based machine learning model, one or more bid update actions,
wherein training of the reinforcement learning-based machine learning model seeks a policy that maximizes estimated cost per action-based reward.

10. The computer-implemented method of claim 9, wherein the observations received from the online advertisement environment comprise one or more of conversion rate, spend rate, cost per action, and cost per mile.

11. The computer-implemented method of claim 9, wherein the reinforcement learning-based machine learning model includes an actor and a critic.

12. The computer-implemented method of claim 9, wherein the reinforcement learning-based machine learning model is implemented via A2C or A3C.

13. The computer-implemented method of claim 9, wherein the estimated cost per action-based reward is implemented via a reward function that:
utilizes, under a circumstance where an estimated cost per action is greater than a target cost per action, deviation of the estimated cost per action from the target cost per action, and
utilizes, under a circumstance where the estimated cost per action is less than the target cost per action, deviation of estimated pacing from desired pacing.

14. The computer-implemented method of claim 9, further comprising:
utilizing, by the computing system, bid multipliers to account for incrementality differences across ad entities.

15. A system comprising:
at least one processor; and
a memory storing instructions that, when executed by the at least one processor, cause the system to perform the computer-implemented method of claim 9.

16. A non-transitory computer-readable storage medium including instructions that, when executed by at least one processor of a computing system, cause the computing system to perform the computer-implemented method of claim 9.

17. A computer-implemented method, comprising:
providing, by a computing system, to a reinforcement learning-based machine learning model, observations received from an online advertisement auction house environment; and
receiving, by the computing system, from the reinforcement learning-based machine learning model, one or more bid multiplier actions,
wherein training of the reinforcement learning-based machine learning model seeks a policy that maximizes conversion reward issued by the online advertisement auction house environment.

18. The computer-implemented method of claim 17, wherein the observations received from the online advertisement auction house environment comprise one or more of audience segment spend rates or audience segment conversion rates.

19. The computer-implemented method of claim 17, wherein the reinforcement learning-based machine learning model is implemented via A2C or A3C.

20. The computer-implemented method of claim 17, wherein the bid multiplier actions are applied to bid update actions generated by a further reinforcement learning-based machine learning model.

21. A system comprising:
at least one processor; and
a memory storing instructions that, when executed by the at least one processor, cause the system to perform the computer-implemented method of claim 17.

22. A non-transitory computer-readable storage medium including instructions that, when executed by at least one processor of a computing system, cause the computing system to perform the computer-implemented method of claim 17.
